(19) United States
(12) Patent Application Publication
(10) Pub. No.: US 2002/0070645 A1
(43) Pub. Date: Jun. 13, 2002

(54) High efficiency, extended life spark plug having improved firing tips

(76) Inventors: Randolph kwok-Kin Chiu, Davison, MI (US); David Allen Smith, Fenton, MI (US)

Correspondence Address: DELPHI TECHNOLOGIES, INC., Legal Staff, Mail Code: 480-414-420, P.O. BOX 5052, Troy, MI, 48007-5052, US

(21) Appl. No.: 09/735,132

(22) Filed: Dec. 12, 2000

(51) Int. Cl. H01T 13/20

(52) U.S. Cl. 313/141; 313/143; 445/7

(57) ABSTRACT

A firing tip for a spark plug assembly comprises an iridium-rhodium alloy. The firing tip is resistance welded to an electrode for use with a long life spark plug. A thermal expansion dividing layer can be bonded between the electrode surface and iridium-rhodium firing tip to prevent peeling, cracking and/or spalling due to thermal stress fatigue. The thermal expansion dividing material can be a platinum-nickel alloy having a coefficient of thermal expansion compatible with both the electrode material and iridium-rhodium alloy.

### TECHNICAL FIELD

This disclosure relates to spark plugs and, more particularly, to spark plugs for spark ignition engines.

### BACKGROUND

Conventional spark plugs are continually being improved to extend their useful lifespan. Historically, spark plugs typically utilized chips manufactured from noble metal alloys such as platinum. Recently though, these chips have been improved to reduce the demand or sparking voltage across the plug gap to enhance engine performance. For instance, United Kingdom Application GB2302367A to Nippondenso Co. Limited discloses a spark plug having a noble metal chip, such as an iridium alloy with another noble metal, such as rhodium, platinum or palladium, in an amount of 1-60% by weight, laser bonded or resistance welded to an electrode. However, GB2303367A teaches that the welded noble metal chip's diameter and length must be limited to ensure a stable weld forms so that the firing chip does not subsequently break off.

Consequently, there exists a need for a spark plug that extends the useful lifespan of existing conventional spark plugs.

### SUMMARY

The drawbacks and disadvantages of the prior art are overcome by the exemplary embodiment of the spark plug assembly, and methods for fabricating the firing tips of the spark plug assembly. A spark plug assembly comprises a shell, an insulator body disposed within said shell. Within the insulator body is a center terminal comprising a center electrode, while a ground terminal comprising a ground electrode extends from the shell. One or both of the electrodes, center electrode and ground electrode, have a Resistance welded firing tip. Preferably, these firing tips are coaxially aligned to define a spark gap. The firing tips can be fabricated by resistance welding an electrically conductive wire to the appropriate electrode. The electrically conductive wire is cut to form an initial tip. The tip is then coined to form the firing tip.

### BRIEF DESCRIPTION OF THE DRAWINGS

Referring now to the figures, which are meant to be exemplary, not limiting, and wherein like elements are numbered alike in the following Figures.

FIG. 1 illustrates a partial cross-sectional view of an exemplary embodiment of a spark assembly employing an embodiment of a firing tip.

FIGS. 2-4 illustrate the steps in the fabrication process of the firing tip of the center electrode.

FIGS. 5-8 illustrate the steps in the fabrication process of the firing tip of the ground electrode.

FIG. 9 illustrates a partial cross-sectional view spark plug assembly employing an alternative embodiment of the firing tips.

FIGS. 10-14 illustrate the steps in the fabrication process of the firing tip of the center electrode.

FIGS. 15-19 illustrate the steps in the fabrication process of the firing tip of the ground electrode.

### DESCRIPTION OF THE PREFERRED EMBODIMENT

An spark plug assembly comprises a shell that houses an insulator body. The insulator body electrically isolates a center terminal from a ground terminal. The center terminal includes a center electrode, which is disposed within a passage in the insulator body, while the ground terminal includes an L-shaped ground electrode, which is attached, typically by welding, to the shell. The center electrode and insulator body protrude beyond an end of the shell, while the center electrode further protrudes beyond the insulator body to define a firing tip. The ground electrode also defines a firing tip positioned opposite the firing tip of the center electrode. Both firing tips further comprise a firing surface, respectively.

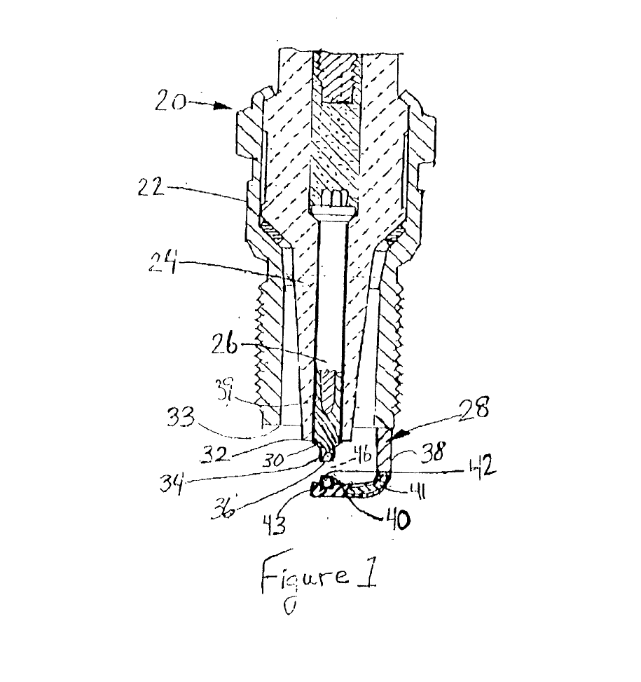

FIG. 1 illustrates an embodiment of a spark plug assembly. A spark plug assembly 20 comprises a shell 22 that houses an insulator body 24, which electrically isolates a center terminal 26 from a ground terminal 28. The center terminal 26 further comprises a center electrode 30 disposed within at least a portion of a first end 32 of a passage in the insulator body 24. The center electrode 30 and insulator body 24 protrude outward from the first end 33 of shell 22, and center electrode 30 protrudes outward even further from the insulator body 24 to define an exemplary firing tip 34. The firing tip 34 further defines a firing surface 36.

Disposed opposite the firing tip 34 is a second firing tip 40 affixed to a first end 43 of an L-shaped ground electrode 38 that extends from and is contiguous to the first end 33 of the shell 22. The firing tip 40 further defines a firing surface 42. The second firing tip 40 is coaxially aligned with firing tip 34, and located between the center and ground electrodes 30 and 38. The space formed between the firing tips 34, 40 further defines a spark gap 46.

The shell 22 comprises a ferrous material, or an alloy comprising a ferrous material, and the like, such as a stainless steel, for example, belonging to the 400-Series, such as SS-409, SS-439, and SS-441, as well as belonging to the 300-Series, such as SS-304 and SS-316, or the 1000-Series such as SAE-1008 and SAE-1010, or a stainless steel alloy comprising at least one of the foregoing stainless steels and nickel, or nickel plating, and combinations comprising at least one of the foregoing stainless steels, alloys, or ferrous materials, and the like. The center electrode 30 and ground electrode 38 can both comprise an electrically conductive material disposed about a thermally conductive core 39, 41, respectively. The electrically conductive material comprises a metal or alloy, and the like, or combinations comprising at least one of the foregoing. For example, the electrically conductive material can be a transition metal and alloys thereof, such as nickel, chromium, iron, manganese, silicon, and combinations and alloys comprising at least one of the foregoing materials with “INCONEL 600” preferred. INCONEL 600 is commercially available from Gibbs Wire & Steel Co., Inc, and possesses a coefficient of thermal expansion of about 16.7 um/m-° C. at about 900° C.

The thermally conductive cores 39, 41 of both the center and ground electrodes comprises a thermally conductive material, which lowers the operating temperature of the electrodes under conditions such as spark ignition engine conditions, that can comprise a thermally conductive material. For example, a thermally conductive material comprising a transition metal can be employed, such as silver, copper, and the like, as well as alloys, mixtures and combinations compromising at least one of the foregoing, and the like.

The firing tips 34, 40 preferably comprise an electrically conductive material affixed to both the center and ground electrodes. Possible materials include platinum, palladium, iridium, rhodium, other noble metals, as well as alloys and mixtures, and combinations comprising at least one the foregoing, and the like, with platinum, iridium, or a platinum-iridium alloy preferred. These electrically conductive materials typically possess a coefficient of thermal expansion value in the range of about 10.0 um/m-° C. to about 8.5 um/m-° C., at about 900° C. The preferred electrically conductive material can be an iridium-rhodium alloy, having a rhodium content up to about 80% by weight, and up to about 60% by weight preferred, and up to about 40% by weight (referred to as “Ir-40Rh”) especially preferred.

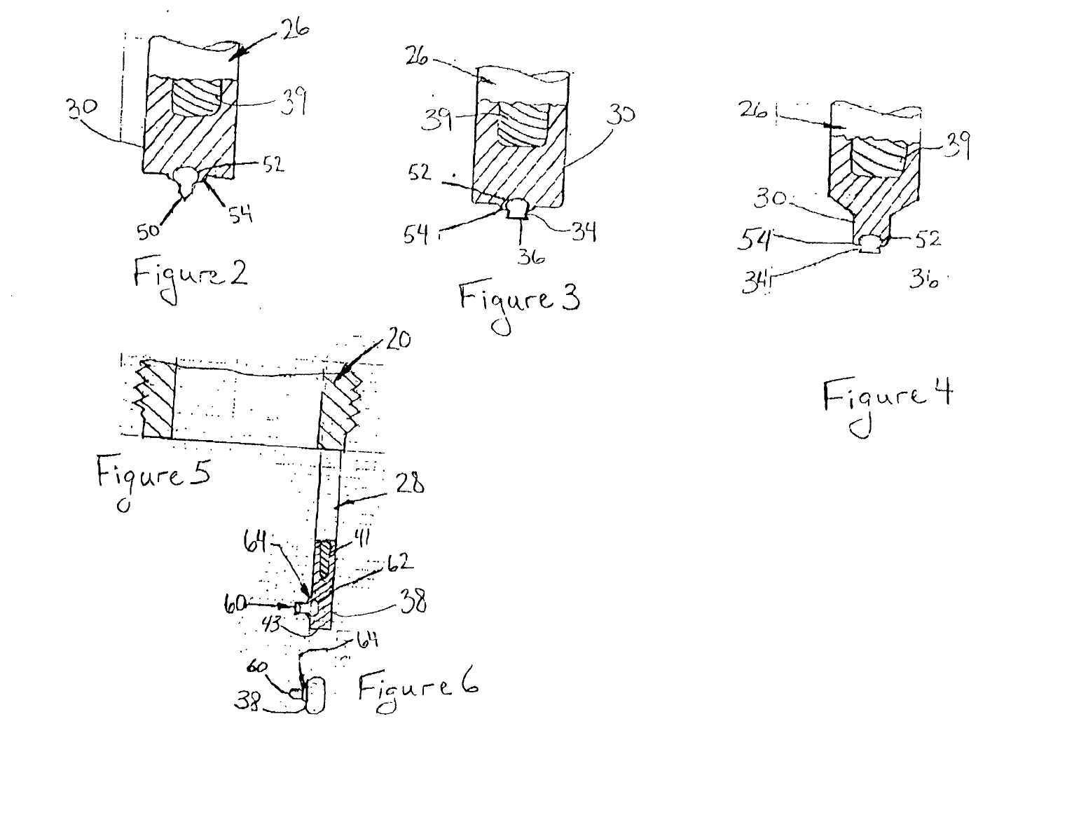

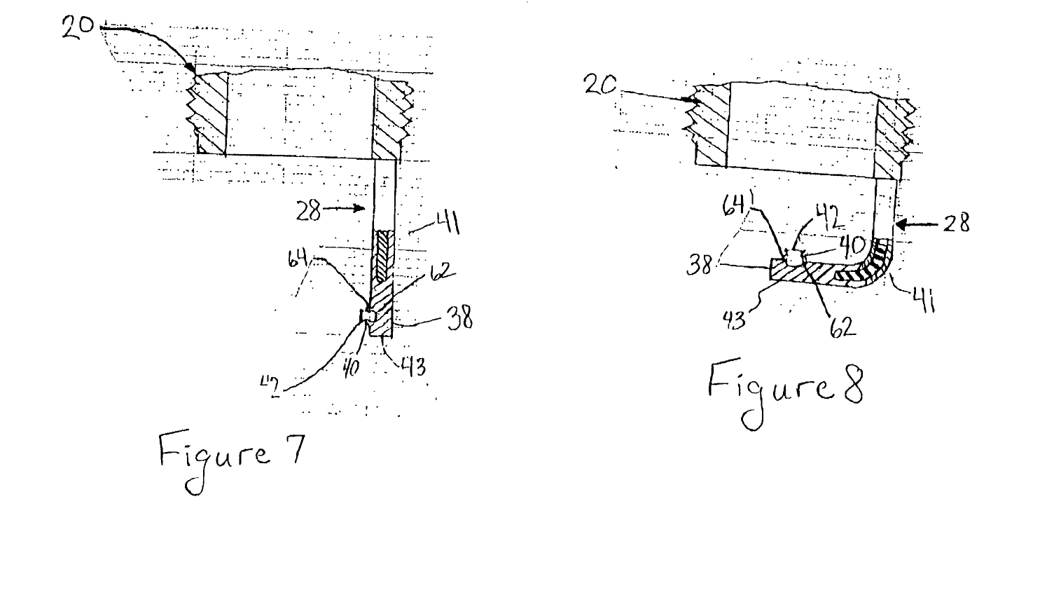

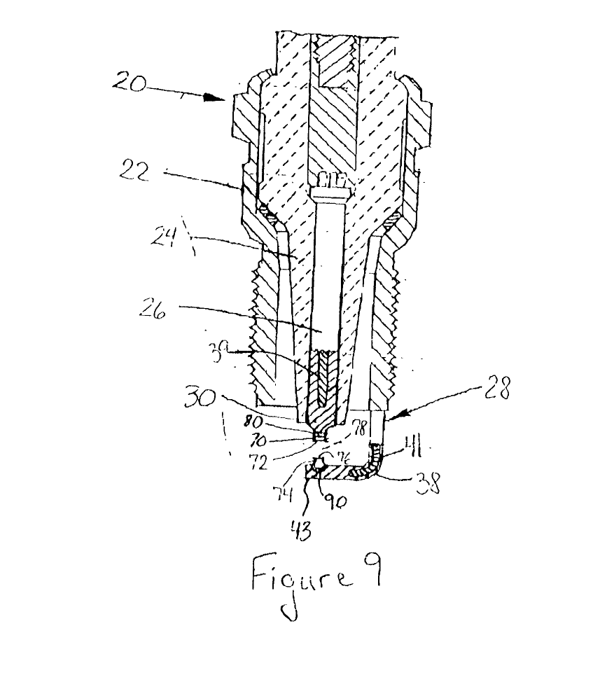

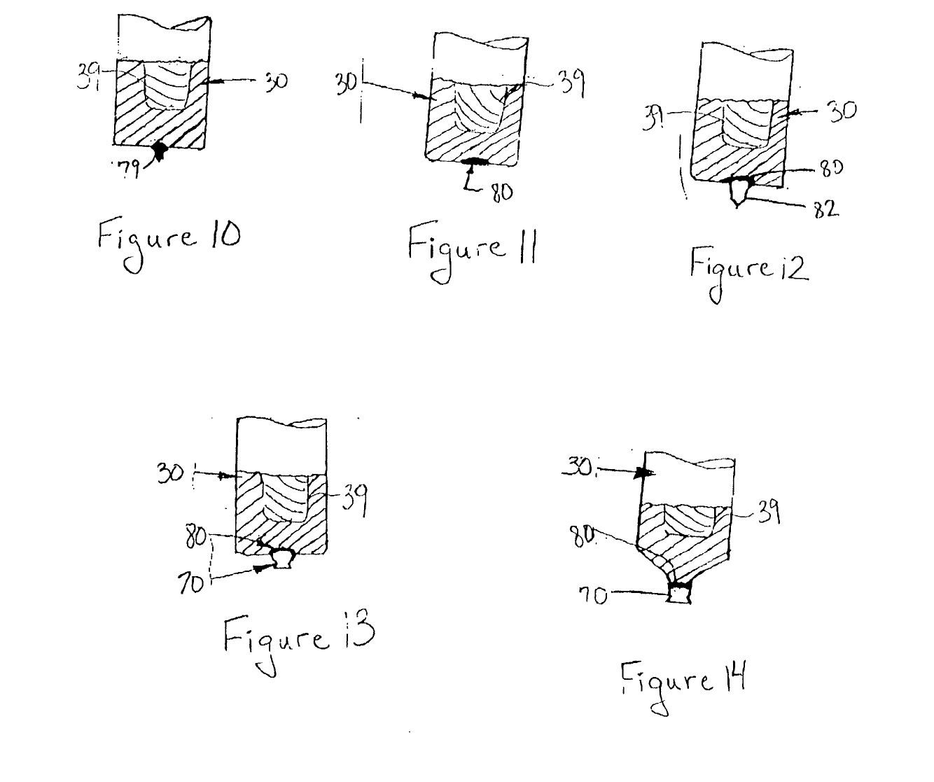

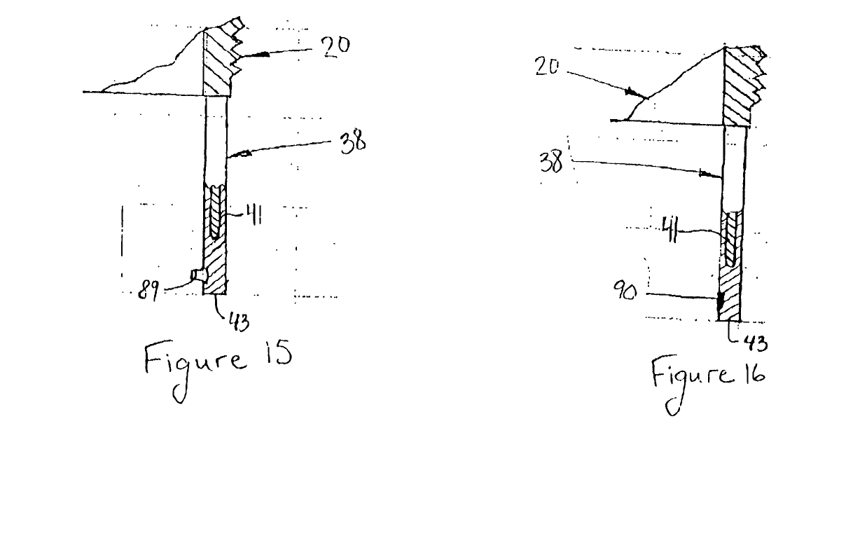

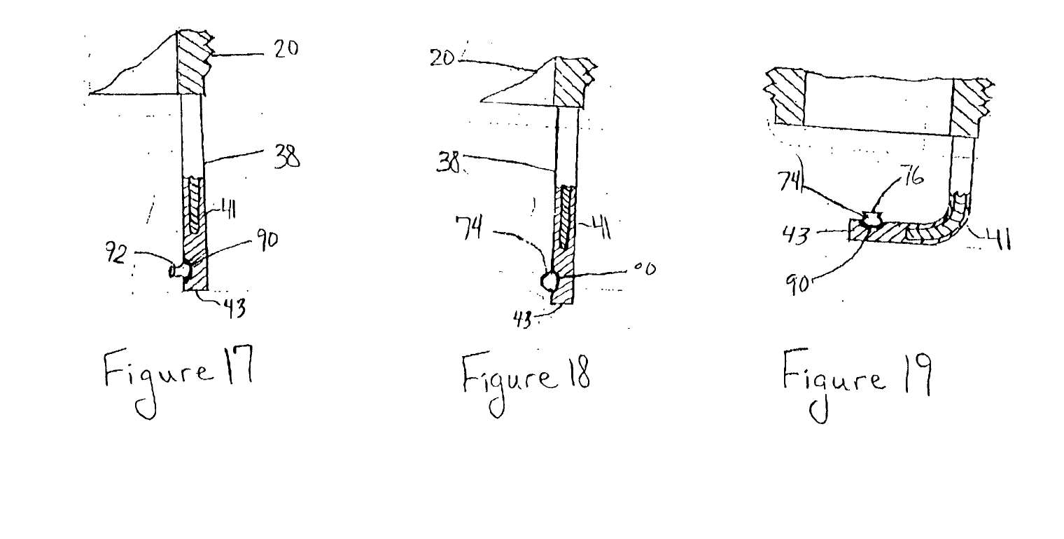

The exemplary firing tips 34, 40 of the spark plug assembly 20 can be manufactured according to the illustrations of FIGS. 2-8. More specifically, FIGS. 2-4 can illustrate the fabrication of the center electrode's exemplary firing tip. A wire can be held in place using any known technique, such as a collet, and the like, for resistance welding to the center electrode 30. A continuous wire feeding and resistance welding procedure can weld the wire, comprising an electrically conductive material, and having a diameter up to about 2.00 millimeters (mm), and up to about 1.00 mm preferred, and about 0.45 mm to about 0.70 mm especially preferred, to the base of center electrode 30. The wire can subsequently be cut to an appropriate length to form an initial firing tip 50 for the center electrode 30 (See FIG. 2). During the resistance welding procedure, the initial firing tip 50 penetrates the base of the center electrode 30 to form a balloon shape 52. At the same time center electrode material contiguous to the balloon shape 52 melts, a weld flash 54 forms to “lock” and position the initial firing tip 50 within the center electrode 30. The initial firing tip 50 can be coined, or flattened, to form a firing tip 34 having a diameter up to about 2.00 mm, and up to about 1.00 mm preferred (See FIG. 3). A portion of the center electrode 30 can be narrowed in diameter, using any number of conventional techniques such as trimming, and the like, to a diameter of about 0.50 millimeters (mm) to a diameter of about 1.00 mm, and a height of about 0.50 mm to about 1.00 mm. The dimensions of each component are ultimately dependent upon the overall size of the spark plug assembly, and therefore may vary substantially with each particular application.

FIGS. 5-8 can illustrate the fabrication of the ground electrode's exemplary firing tip. A wire can be held in place by any known technique, such as a collet, and the like, for resistance welding to the ground electrode 38. A continuous wire feeding and resistance welding procedure can weld the wire comprising an electrically conductive material, and having a diameter of up to about 2.00 mm, and up to about 1.00 mm preferred, and about 0.45 mm to about 0.70 mm especially preferred, to the first end 43 of the ground electrode 38 (See FIG. 5). The wire can subsequently be cut to an appropriate length to form an initial firing tip 60 (See FIGS. 5, 6). During the resistance welding procedure, the initial firing tip 60 penetrates the base of the ground electrode 38 to form a balloon shape 62. At the same time ground electrode material contiguous to the balloon shape 62 melts, a weld flash 64 forms to “lock” and position the initial firing tip 60 within the ground electrode 38 (See FIG. 5,6). The initial firing tip 60 can be coined, or flattened, to form a firing tip 40 having diameter of up to about 1.50 mm, and up to about 1.00 mm preferred, and a height of up to about 1.00 mm, and up to about 0.75 mm preferred (See FIG. 7). The ground terminal 28 can be bent using a conventional technique, such that the firing tip 40 is coaxially aligned with the firing tip 34 of the center electrode 30 to form the spark gap 46 (See FIGS. 1 and 8). The dimensions of each component are ultimately dependent upon the overall size of the spark plug assembly, and therefore may vary substantially with each particular application.

FIG. 9 illustrates an alternative embodiment of the firing tips. For purposes of illustration, the spark plug assembly of FIG. 9 comprises components similar to the spark plug assembly of FIG. 1. Spark plug assembly 20 further comprises a center electrode 30 that defines an exemplary firing tip 70 affixed to a thermal expansion divider layer 80. The firing tip 70 further defines a firing surface 72. The spark plug assembly 20 also further comprises a ground electrode 38 that defines an firing tip 74 affixed to a thermal expansion divider layer 90, coaxially aligned with firing tip 70, and located between the center and ground electrodes 30 and 38. The firing tip 74 further defines a firing surface 76. The space formed between the firing tips 70, 74 further defines a spark gap 78.

The pair of thermal expansion divider layers 80 and 90 are affixed to the center and ground electrodes 30 and 38, respectively, by any known techniques such as a welding operation, with a resistance welding operation preferred, and serving as a base for the firing tips 70 and 74. The thermal expansion divider layers 80 and 90 comprise an electrically conductive material such as an electrically conductive metal, alloy, mixture, and combinations. Possible electrically conductive materials include iron, chromium, aluminum, manganese, silicon, as well as, alloys, and mixtures compromising iron, chromium, platinum, nickel, aluminum, manganese, silicon, and the like, and combinations comprising at least one of the foregoing, with an alloy comprising platinum and nickel preferred, and an alloy comprising platinum and up to about 15% by weight of nickel especially preferred, such as the Pt-10Ni alloy.

FIGS. 10-14 can illustrate the fabrication of the center electrode's firing tip 70. A wire 79 can be held in place by any known technique such as a collet, and the like, for resistance welding to the center electrode 30. A continuous wire feeding and resistance welding procedure can weld the wire 79, comprising an electrically conductive material, and having a diameter of up to about 2.00 mm, and up to about 1.00 mm preferred, and about 0.45 mm to about 0.70 mm especially preferred, and a weight of up to about 2.0 milligrams, with up to about 1.00 milligrams preferred, to the base of the center electrode 30 (See FIG. 10). The resistance welded wire 79 can subsequently be cut to an appropriate length, and coined, or flattened, to form a expansion divider layer 80 flush, e.g., having a height of up to about 0.05 mm above the center electrode's surface, with up to about 0.03 mm preferred, to the center electrode's surface (See FIG. 11). The thermal expansion divider layer 80 can have a geometry such as disc shaped, and a thickness of up to about 1.00 mm, with up to about 0.50 mm preferred, and up to about 0.25 mm especially preferred. The dimensions of each component are ultimately dependent upon the overall size of the spark plug assembly, and therefore may vary substantially with each particular application.

A wire can be held in place using any known technique, such as a collet, and the like, for resistance welding to the thermal expansion divider layer 80. The wire, comprising an electrically conductive material, and having a diameter of up to about up to about 2.00 mm, and up to about 1.00 mm preferred, and about 0.45 mm to about 0.70 mm especially preferred, is resistance welded to the thermal expansion divider layer 80. The wire can subsequently be cut to an appropriate length to form an initial firing tip 82 within the center electrode 30 (See FIG. 12). The initial firing tip 82 can be coined, or flattened, to form firing tip 70 having a diameter of up to about up to about 2.00 mm, and up to about 1.00 mm preferred (See FIG. 13). The firing tip 70, and a portion of the center electrode 30, can be narrowed in diameter, using any number of conventional techniques such as trimming, and the like, to a diameter of about 0.50 mm to a diameter of about 1.00 mm, and a height of about 0.50 mm to about 1.00 mm (See FIG. 14). The dimensions of each component are ultimately dependent upon the overall size of the spark plug assembly, and therefore may vary substantially with each particular application.

FIGS. 15-19 can illustrate the fabrication of the ground electrode's exemplary firing tip 74. A wire 89 can be held in place using any known technique, such as a collet, and the like, for resistance welding to the ground electrode 38. A continuous wire feeding and resistance welding procedure can weld the wire 89 comprising an electrically conductive material, and having a diameter up to about 2.00 mm, and up to about 1.00 mm preferred, and about 0.45 mm to about 0.70 mm especially preferred, to the ground electrode 38 (See FIG. 15). The resistance welded wire 89 can be subsequently severed, and coined, or flattened, to form a thermal expansion divider layer 90 flush to the ground electrode's surface (See FIG. 16). The thermal expansion divider layer 90 can have a geometry such as disc shaped, and a thickness of up to about 1.00 mm, with up to about 0.50 mm preferred, and up to about 0.25 mm especially preferred. The dimensions of each component are ultimately dependent upon the overall size of the spark plug assembly, and therefore may vary substantially with each particular application.

The wire comprising an electrically conductive material, and having a diameter of up to about up to about 2.00 mm, and up to about 1.00 mm preferred, and about 0.45 mm to about 0.70 mm especially preferred, is resistance welded to the thermal expansion divider layer 90. A wire can be held in place by any known techniques, such as using a collet, and the like, for resistance welding to the thermal expansion divider layer 90. The wire can subsequently be cut to an appropriate length to form an initial firing tip 92 within the ground electrode 38 (See FIG. 17). The initial firing tip 92 can be coined, or flattened, to create a firing tip having a diameter of up to about 2.00 mm, and up to about 1.00 mm preferred (See FIG. 18). The ground terminal 28 is bent using a conventional technique, such that the firing tip 74 is coaxially aligned with the firing tip 70, and located between the center and ground electrodes 30 and 38, to form a spark gap 78 (See FIGS. 9 and 19).

The exemplary methods for fabricating the firing tips are further illustrated by the following non-limiting examples.

### EXAMPLE 1

A Ir-40Rh wire is secured by a collet to the base of the center electrode for resistance welding. The Ir-40Rh wire, having a diameter of about 0.55 mm, is resistance welded to the base of the center electrode made from INCONEL 600, and having a silver or copper core. The resistance welded wire is severed to 0.90 mm in length, and coined to form a mushroomed shaped firing tip having a diameter of 0.80 mm, and a height of 0.50 mm (See FIG. 3). A portion of the center electrode, is then sized to 0.90 mm in diameter, and 0.75 mm in height. This same procedure can be implemented to fabricate the firing tip for the ground electrode, however; the ground electrode does not undergo a sizing operation to narrow its cross-sectional area, and its firing tip does not undergo a sizing operation to narrow its diameter.

The resulting spark plug assembly was tested for about 1,000 hours, which is at least about 100,000 miles, to up to about 200,000 miles using a 2.3 liter dynamometer engine. No significant increase in spark gap erosion or sparking voltage was noted as a result of the test. In addition, only partial oxidation occurred at both weld interface of the electrode and thermal expansion divider layer, and the thermal expansion divider layer and firing tip.

The resulting firing tip and thermal expansion divider layers were heated up to about 830° C., and cooled to about 300° C., under an atmosphere comprising an ethylene gas mixture, for up to about 90,000 cycles at of about seven seconds a piece. Under these conditions, the firing tip adhered to an electrode material, and did not fall off.

### EXAMPLE 2:

A Pt-10Ni wire is secured by a collet to the base of the center electrode for resistance welding. The Pt-10Ni wire, having a diameter of 0.45 mm, is resistance welded to a center electrode made from INCONEL 600, and having a silver or copper core. The resistance welded Pt-10Ni wire is severed to 0.70 mm, and coined to from a disc shaped thermal expansion divider layer having a diameter of 0.80 mm, and a thickness of 0.50 mm.

A Ir-40Rh wire is secured by a collet to the base of the thermal expansion divider layer for resistance welding. The Ir-40Rh wire, having a diameter of 0.55 mm, is resistance welded to the thermal expansion divider layer. The resistance welded wire is severed to about 0.90 mm in length, and coined to form a mushroomed shaped firing tip having a diameter of about 0.80 mm, and a height of about 0.50 mm. The firing tip, including a portion of the center electrode and thermal expansion divider layer, is then sized to about 0.75 mm in diameter, and about 0.75 mm in height (See FIG. 13 and 14). This same procedure can be implemented to fabricate the thermal expansion divider layer, and firing tip, for the ground electrode, however; the firing tip and thermal expansion divider layer do not, undergo a sizing operation to narrow their diameters.

The exemplary firing tips possess several advantages over conventional noble metal chips, and their methods of fabrication. First, fabricating the exemplary firing tips using resistance welding prevents damaging the spark plug electrodes. Due to differences in melting points, boiling points, and coefficients of thermal expansion between the nickel alloys and noble metal alloys, as well as the diminutive size of the spark plug components, laser welding is more likely to damage the spark plug electrodes.

Second, fabricating the exemplary firing tips using resistance welding of wires, prevents the firing tip from falling off due to peeling, spalling or cracking. As described above, the resistance welded Ir-40Rh wire balloons within the electrode such that the wire anchors itself within the electrode material. The exemplary firing tips are further secured by the weld flash in the first embodiment, while the Pt-10Ni layer effectively bonds the iridium-rhodium alloy to the nickel based alloy of the electrode in the second embodiment.

Third, pure iridium metal is a very hard and brittle material, having a high melting point of approximately 2447° C., and a high boiling point. When used in spark plug applications, pure iridium is resistant to spark erosion if the operating temperature is lower than approximately 900° C. Above that temperature, iridium forms an oxide that sublimates or erodes away. These physical properties make it difficult to fabricate components using pure iridium because pure iridium will not puddle outward or “balloon” during resistance welding. The Ir-40Rh alloy lowers the melting point to approximately 2150° C., making the resulting alloy more ductile and easier to fabricate. The Ir-40Rh alloy also bonds well with Inconel 600 material, such that the alloy puddles outward or “balloons” when being resistance welded. In addition, alloying iridium with rhodium also prevents the iridium from sublimating because the rhodium will form a protective oxide coating on the exterior surface of the iridium to prevent the formation of the sublimate oxide.

Fourth, the Pt-10Ni thermal expansion divider layer possesses a coefficient of thermal expansion (CTE) falling between the values possesses by the exemplary firing tip material and electrode material. The thermal expansion divider layer divides the substantially large CTE value difference between the electrode material and firing tip material into two smaller CTE value differences, and provide a gradual transition in CTE values. The resulting combination of materials is less likely to experience premature thermal fatigue failure, such that the firing tip is less likely to peel, spall and/or crack and break off the exemplary thermal expansion divider layer.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A spark plug assembly, comprising:
a shell;
an insulator body disposed within said shell;
a center terminal comprising a center electrode disposed within said insulator body;
a ground terminal comprising a ground electrode extending from and contiguous to said shell;
a resistance welded firing tip disposed on said center electrode and said ground electrode, wherein said firing tips are coaxially aligned to define a spark gap.

2. The spark plug of claim 1, further comprising a resistance welded thermal expansion divider layer disposed between said electrodes and said firing tip.

3. The spark plug of claim 2, wherein said thermal expansion divider layer comprises an electrically conductive material selected from the group consisting of platinum, rhodium, palladium, iridium, nickel, and combinations comprising at least one of the foregoing materials.

4. The spark plug of claim 3, wherein said electrically conductive material comprises platinum and up to 15% by weight of nickel.

5. The spark plug of claim 1, wherein said firing tips further comprise a noble metal.

6. The spark plug of claim 5, wherein said noble metal is selected from the group consisting of platinum, rhodium, iridium, palladium, and alloys and combinations comprising at least one of the foregoing noble metals.

7. The spark plug of claim 6, wherein said firing tips further comprise iridium and up to about 60% by weight of rhodium.

8. The spark plug of claim 7, wherein said firing tips further comprise iridium and up to about 40% by weight of rhodium.

9. A method for fabricating a firing tip, comprising:
resistance welding an electrically conductive wire to an electrode;
cutting said electrically conductive wire to form an initial tip; and
coining said initial tip to form a firing tip.

10. The method of claim 9, further comprising affixing said electrically conductive wire to said electrode for resistance welding using a collet.

11. The method of claim 9, further comprising penetrating said electrode with said electrically conductive wire during said resistance welding.

12. The method of claim 9, further comprises forming a weld flash, wherein said resistance welded electrically conductive wire penetrates said electrode.

13. The method of claim 9, wherein said electrically conductive wire further comprises a metal selected from the group platinum, rhodium, iridium, nickel, palladium, and alloys and combinations comprising at least one of the foregoing metals.

14. The method of claim 13, wherein said first electrically conductive wire further comprises platinum and up to about 15% by weight of nickel.

15. The method of claim 14, wherein said first electrically conductive wire further comprises iridium and up to 40% by weight of rhodium.
